(19) United States
(12) Patent Application Publication
(10) Pub. No.: US 2007/0284429 A1
(43) Pub. Date: Dec. 13, 2007

(54) COMPUTER COMPONENT RECOGNITION AND SETUP

(75) Inventor: Steven Beeman, Kirkland, WA (US)

Correspondence Address: BANNER & WITCOFF, LTD.;ATTORNEYS FOR CLIENT NOS. 003797 & 013797, 1100 13th STREET, N.W., SUITE 1200, WASHINGTON, DC, 20005-4051, US

(73) Assignee: Microsoft Corporation, Redmond, WA (US)

(21) Appl. No.: 11/423,883

(22) Filed: Jun. 13, 2006

(51) Int. Cl. G06F 17/00

(52) U.S. Cl. 235/375

(57) ABSTRACT

Methods and systems are provided for determining compatibility of a computer component with a particular computer configuration. In one embodiment, a user of a computing device may identify whether a hardware or software component the user wants to install in the computing device is compatible before opening the packaging. In another embodiment, a sensor detects an identifier of a computer component that is associated with a packaging without the user having to unseal the component. Information on the identifier may be compared with a list indicting compatibility and/or with that particular computer's configuration. Further aspects relate to installation procedures upon detecting a computer component is compatible. In one example, the computing device may perform one or more of the following steps: install the correct drivers automatically, provide plug-in and setup instructions, and warn the user about incompatibilities or otherwise help the user through the process.

### BACKGROUND

Users frequently update the software and/or hardware components on their computing devices. Upgrading may be in the form of hardware peripherals, such as a graphics card that can display more colors to a software package, such as a word processing suite having more options. Upgrading computing devices can be a laborious and frustrating process, due to numerous reasons. For example, when installing a new graphics card to play high quality digital video, such as on a computer running Microsoft® XP operating system, a user must make sure that they have a compliant version of the operating system. For example, the Microsoft® XP Media Center 2004 operating system may support the graphics card; however, Microsoft XP Media Center 2005 may not. Moreover, due to similarities in the user interface, the average user is unaware of which brand of version of the operating system they are currently utilizing. Moreover, other software installed on the computer, both from Microsoft® as well as other third-party vendors, may have different requirements for a video card.

Past attempts to indicate compatibility have decreased the inconvenience and frustration, however, can be improved upon. One attempt focused on marking certain certified peripherals as “Plug & Play”, in which the user simply has to plug in a peripheral for it to work. Frequently, however, the product still needed to be configured or was not fully compatible. For example, to properly configure a peripheral an installation program must be run before the peripheral is even connected to the machine. This installation software is often shipped with the peripheral on a CD or other computer readable medium, which is wasteful. Moreover, the very first action the CD performs is to connect to the Internet to download an up-to-date version, rendering the CD contents irrelevant.

Moreover, some peripherals are not compatible with every machine. (An example might be a device that is compatible with Windows XP but does not have Vista drivers yet.) Often, users do not realize this until they have already opened the packaging. The opened product then cannot be returned (hurting the user), is returned but cannot be resold (hurting the retailer), or is returned to the manufacturer as defective (hurting the manufacturer).

This scenario may further be complicated by hardware compatibility issues. For example, different main-boards or motherboards utilize different standards when receiving input, such as video input. Some main-boards utilize an AGP slot whereas others utilize a PCI-Express slot, and still yet others have built in video components and therefore do not have either an AGP or PCI-Express slot. Even if a product is labeled as not requiring any configuration by the user, the purchaser may be unaware that they purchased a component with the wrong connection type until the package has been opened and they are attempting to place the hardware into the machine. Similarly, software is often not compatible with a computer. It might require a different OS, more system resources than are available, special peripherals, etc. If the user doesn't realize this until the package is opened, the same return problems mentioned above apply.

### SUMMARY

Aspects of the invention permit a user of a computing device to identify whether a hardware or software component the user wants to install in the computing device is compatible with the computing device before opening the packaging. In one embodiment, a sensor detects an identifier of a computer component that is associated with the packaging without the user having to unseal the component. In one such example, information on the identifier is compared with a list indicting compatibility. In yet another example, the information gathered from the identifier is compared with that particular computer's configuration to determine if the computer component is compatible with the computer configuration.

Further aspects of the invention relate to installation procedures upon detecting an identifier reveals the computer component is compatible with the computing device. In one example, the computing device may perform one or more of the following steps: install the correct drivers automatically, provide plug-in and setup instructions, and warn the user about incompatibilities or otherwise help the user through the process.

These and other advantages will become apparent from the following detailed description when taken in conjunction with the drawings. A more complete understanding of the present invention and the advantages thereof may be acquired by referring to the following description in consideration of the accompanying drawings, in which like reference numbers indicate like features. The invention is being described in terms of exemplary embodiments. Numerous other embodiments, modifications and variations within the scope and spirit of the appended claims will occur to persons of ordinary skill in the art from a review of this disclosure.

### BRIEF DESCRIPTION OF THE DRAWINGS

FIG. 1 shows an exemplary system for implementing select embodiments or portions of select embodiments of the invention.

FIG. 2 shows exemplary embodiments of computer components having one or more identifiers or tags that are detectable while the component is associated with a packaging.

FIG. 3 is an exemplary flow diagram of a method for determining compatibility of a computer component.

### DETAILED DESCRIPTION

### Simplified Computing Device Description

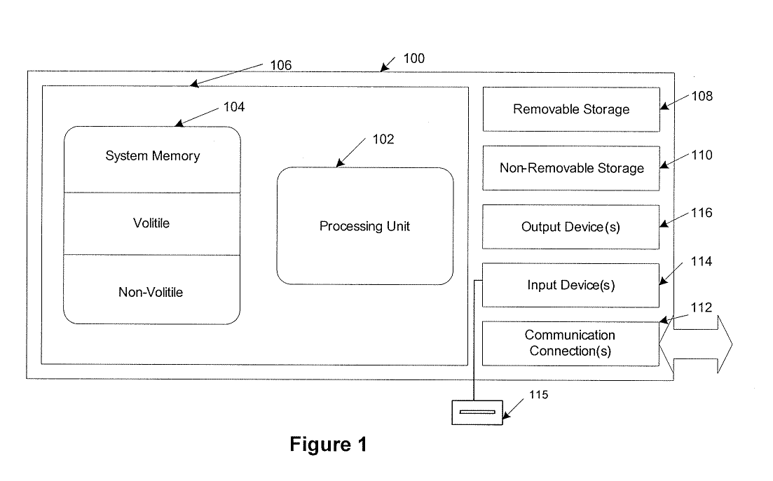

With reference to FIG. 1, an exemplary system for implementing select embodiments or portions of select embodiments includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106. Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

Device 100 may also contain communications connection(s) 112 that allow the device to communicate with other devices. Communications connection(s) 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Device 100 may also have input device(s) 114 such as keyboard, mouse, pen, voice input device, touch input device, etc. In the illustrated example, device 100 includes sensor 115 operatively connected to the device. While a wired connection is shown, one skilled in the art that a sensor may be connected wirelessly, such as a remote location, such as a store. Sensor 115 is configured to sense a component identifier (as explained throughout the remaining Specification).

Output device(s) 116 such as a display, speakers, printer, etc. may also be included. All these devices are well know in the art and need not be discussed at length here.

### Description of Illustrative Embodiments

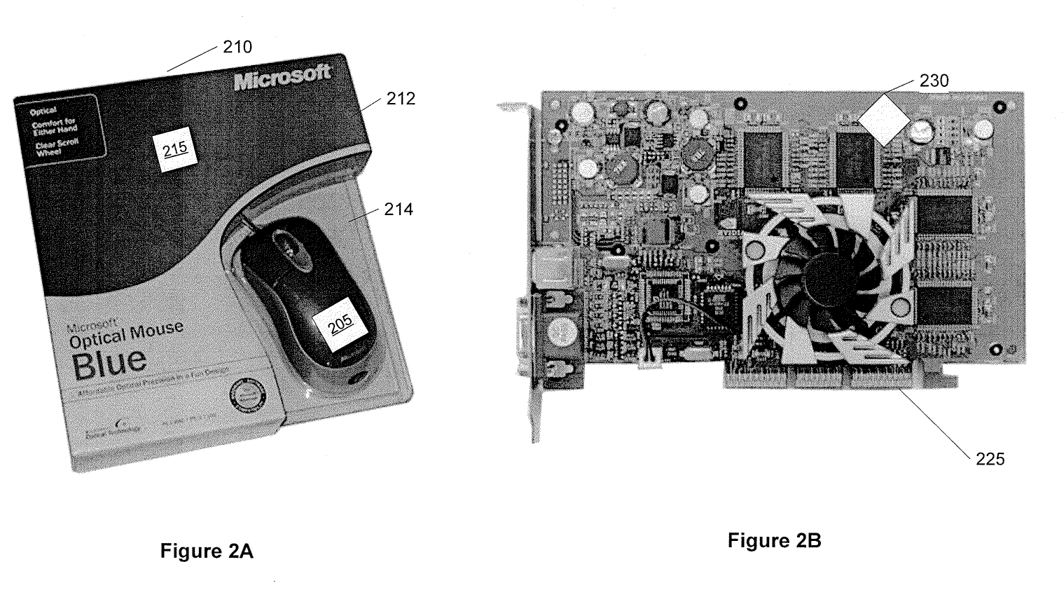

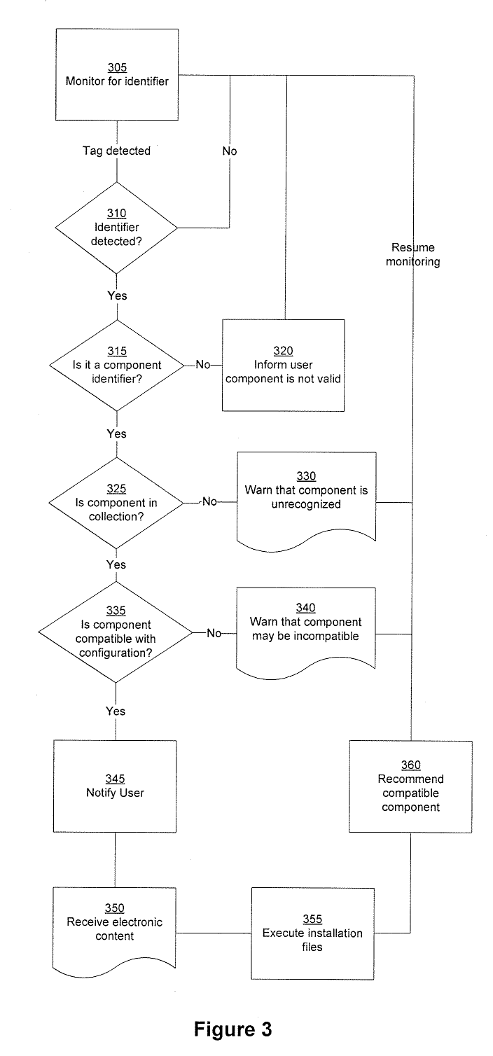

FIG. 2 shows exemplary embodiments of a computer component associated with packaging, having one or more identifiers or tags that are detectable while associated with the packaging. The packaging may be any material or structure that holds a product and/or data. For example paper, cardboard, plastic, wood, metal, and the like may be used. The identifier or tag may be, for example, a bar code, radio frequency identification (RFID) tag, data recorded magnetically, or any suitable identifying device. In one embodiment, an existing UPC code may be used as an identifier. In another embodiment, a unique IR-reflective pattern may be utilized. More specific usage of the identifiers will be explained in reference to the exemplary method shown in FIG. 3. As one skilled in the art will readily understand, any mark, symbol, or indicia that may communicate the identification of the packaged component is an identifier within the scope of this disclosure.

FIG. 2A shows computer component 205, an optical mouse, housed in exemplary packaging 210. Exemplary packaging 210 comprises an outer shell of cardboard 212 and an inner shell of transparent plastic 214. Within the transparent plastic 214 is the computer component 205, which is visible through transparent plastic 214. In one embodiment, one or more identifiers, such as identifier 215 may be placed on the outer periphery of the packaging 210, such as on the outer shell of the cardboard 212. The identifier may be a label, imbedded in the packaging material, or not visible to the purchaser. Another identifier, such as identifier 220, may be positioned, either individually or in conjunction with one more other identifiers, such as identifier 215 on the actual computer component, 205.

One or more identifiers may be placed on any portion of the packaging and/or the computer component as to permit detection externally from the packaging without substantially altering the packaging. As used herein, a substantial alteration would include: breaking a seal that can not readily be reconstructed; permanently comprising the integrity of the packaging, such as ripping a plastic bag from the product, and/or permanently removing a portion of the package that would render the product to be used. Examples of non-substantial alteration would be to: repositioning the packaging in relation to the component without permanently comprising the integrity of the packaging or temporarily removing a portion of the packing without permanently preventing the reconstruction of the packaging. For example, looking to FIG. 2, one embodiment could allow a user to remove the transparent plastic 214 portion of the packaging that encases the component 205 from the outer cardboard shell 212 without breaking the outer shell 212 or unsealing the transparent plastic portion 214. In this embodiment, the outer cardboard shell 212 is merely a sleeve or casing that may be placed directly over the inner plastic portion 214.

The user may scan one or more identifiers and then place the transparent plastic portion 214 back within the cardboard outer portion 212. However, in other embodiments, the manufacturer of seller of the product may wish to not allow the transparent plastic portion 214 to be removed from the outer portion 212, and therefore may place a seal on the outer portion 214, or over the outer portion 214, such as a plastic wrapping. In such cases, removing the transparent plastic portion 214 would constitute a permanent alteration of the packaging.

FIG. 2B illustrates another computer component according to one aspect of the invention. Exemplary computer component 225 may be a graphics card, such as for a general purpose computer, for example, computing device 100. Like identifier 220, identifier 230 is placed on a portion of the component. (For purposes of clarity, an external packaging is not shown, however, the identifier may be placed on the component 225 in such a way that it is detectable through the packaging. In one embodiment, the packaging could have a peel or pull away window that would not permanently alter the packaging. In yet another embodiment, one or more identifiers may comprise an RFID tag that is detectable without being visible. This allows the same detection and installation process to work on products after the packaging is discarded, such as when moving a printer or video card from one computer to another.

FIG. 3 shows an exemplary method of determining the capability of a computer component according to one or more embodiments of the invention. In optional step 305, a computer component or peripheral operatively connected to the computing device may monitor for detection of an identifier. This may be advantageous, for example, to speed up the process to the user and/or more fully automate the process. At step 310, it is determined whether an identifier as discussed above that is associated with a packaging is detected, where the detection is performed without substantially altering the packaging. Step 310 may be conducted by a sensor located on or operatively connected to the computing device in which the computer component will be installed on. In one embodiment, the sensor is remote from the computing device but may upon being detected; information from the identifier(s) may be transmitted to one or more remote locations to determine compatibility. In any of the embodiments, the identifying data carried by the identifier comprises information such as, product identification, serial number, activation codes for executing a script file, a URL or other reference to a web site, or any similar type of information. Indeed, any data that may be electronically transmitted is within the scope of the invention.

If no identifier is detected in step 310, step 305 may be repeated. In one embodiment, step 305 may be repeated a predetermined number of times or for a predetermined period of time. In yet another embodiment, step 305 may continue indefinitely while the computing device is in operation. If, however, an identifier is detected at step 310, optional step 315 may be implemented to determine if it is a valid component identifier. This step may be implemented for various reasons. For example, if a sensor is utilized for multiple functions besides detection of these unique identifiers. For example, the user may have to scan other RFID tags for other purposes besides those outlined within the scope of the invention. Another example for utilizing step 315 may be to identify counterfeit or fake products. As one skilled in the art readily understands there is an ongoing problem with counterfeiters attempting to recreate component packaging to more easily confuse consumers into purchasing fake products. Therefore, step 315 may be implemented to also determine if the identifier is valid.

If at step 315, the identifier is determined not to be a valid component identifier, step 305 may be repeated. Yet in another embodiment, step 320 may be implemented to generate a message (which may be presented, for example, in video, audio, or combinations thereof) indicating the identifier is not valid. If, however, it is determined at step 315 a valid component identifier is detected, one or more compatibility and/or installation processes may be undertaken.

In one embodiment, step 325 may be initiated. At step 225, at least one identifier associated with the component is compared with a collection of identifiers located on a computer-readable medium. In one embodiment, the collection of identifiers may include identifiers associated with computer components certified for use with a class of computers. For example, a “class” may be defined by computers made by one or more specific manufacturers, or in another embodiment it may refer to a group of computers known to have one or more similar configurations. Indeed, a “class” can refer to any group of computing devices having at least one common attribute. In another embodiment, the collection of identifiers may include computer components certified for use with one or more software components.

Yet in still further embodiments, the collection of identifiers may include computer components certified for use with the particular computer configuration. The collection of identifiers may be organized on the computing device for which the component will be installed on or at a remote location that may, for example, be connected to through a wired and/or wireless communication channel. In one embodiment, the collection of identifiers may be stored at a remote database that is accessible through a secure communication channel, wherein and the collection is updated to allow the addition of new identifiers.

If it is determined that the computer component is not located within the collection, optional exemplary step 330 may be implemented to transmit a notification to a user indicating the at least one identifier is not located within the collection of identifiers. For example, in the illustrated example shown in step 330, a message is presented to the user that warns that the component is unrecognized and might be unsupported. The step may also provide information, such as contact information or a link or a web page that provides more specific information. The database may contain information about the hardware and software requirements of the detected component, therefore if the computer does not meet one or more requirements, the user may be alerted before permanently altering the package, so that it may be returned to the point of purchase.

If, however, the identifier is found when searching the collection, step 335 may be performed as well as presenting any notifications to the user, such as indicating the results and/or indicating any recommended updates or modifications. At step 335, which may be implemented before, during, after, or independent of step 330, at least a portion of the information from one or more identifiers that relates to the computer component is compared with the particular computer configuration to determine if the computer component is compatible with the computer configuration. If it is determined that the computer component is not compatible with the computer configuration, optional step 340 may be implemented to transmit a notification to a user indicating that fact. For example, exemplary step 340 transmits a notification warning the user that the component is incompatible and should not be opened or installed. Of course, one skilled in the art will appreciate other messages may be transmitted to the user, such as for example, recommendations for other components that may allow the detected component to be utilized in the computing device. Moreover, other steps may be used independently of or in conjunction with step 340.

If at step 335, it is determined that the component is compatible with the computing device, step 345 may be implemented to notifying a user that the computer component is compatible with the particular computer configuration, or compatible with an update. Step 350 may occur before, during, after, or independently of step 345 upon determining the component is compatible with the computing device in step 345. At step 350, electronic content required or recommended for installing the component in the computing device may be received. Such electronic content may include, but is not limited to: drivers, installation files, manuals, help files and combinations thereof.

Moreover, the computer may, for example in optional step 355, execute installation files for installing such electronic content. For example, one or more steps may allow the installation of correct drivers automatically, provide plug-in and setup instructions, and warn the user about incompatibilities or otherwise help the user through the process. In one embodiment, the electronic content is received from a remote source that may be updated to provide relevant up-to-date content that may be downloaded without having to retrieve older outdated material that historically has been included with the component in the packaging. Therefore, according to one embodiment, no CD or computer-readable medium is required to be packaged with the component, and the correct software is installed before the product is first connected to the computer.

Additionally, in one embodiment that incorporates optional step 360, the user may be notified of a recommended additional computer component that is compatible with the computing device and the component detected in step 305. In one such embodiment, the additional component is a software product that is known to work exceptionally well with the detected component, yet in another embodiment, it may be a hardware component, such as additional memory to increase the performance of the detected component. As one skilled in the art will readily appreciate, any product both, software and hardware is within the scope of this disclosure. Moreover, the component does not have to be directly computer-related, but rather anything that be used with a computer component. For example, special photo-paper may be recommended to a user when a specific printer or class of printers are detected.

In yet another embodiment, one or more identifiers may be transmitted from the packaging of the component to a computer readable medium on a portable device, such as a mobile phone. Therefore, the mobile phone or a component thereof may serve as sensor 315. In one such embodiment, a potential purchaser may receive the identifier without having to first purchase the device. The potential purchaser may then transmit the identifier to the computer device to determine the compatibility, such as by implementing one or more steps described in relation to FIG. 3.

The present invention has been described in terms of exemplary embodiments. Numerous other embodiments, modifications and variations within the scope and spirit of the appended claims will occur to persons of ordinary skill in the art from a review of this disclosure. For example, one skilled in the art will appreciate different methods may be used to conduct the compatibility determination without departing from the scope of the invention. Moreover, one or more steps of the described methods may be omitted or duplicated, for example, steps such as step 345 which conveys information to a user may be utilized throughout the process. Moreover, in some instance the steps may performed in a different sequence than described above.

We claim:

1. A method for determining compatibility of a computer component with a particular computer configuration through detection of identifiers that are detectable externally from a packaging, the method comprising the steps of:
(a) detecting at least one identifier of a computer component that is associated with a packaging, the identifier comprising information relating to the computer component, wherein detection of the at least one identifier is performed without substantially altering the packaging; and
(b) comparing at least a portion of the information relating to the computer component with a particular computer configuration to determine if the computer component is compatible with the computer configuration.

2. The method of claim 1, further comprising the step of:
(c) comparing the at least one identifier with a collection of identifiers located on a computer-readable medium.

3. The method of claim 2, wherein the collection of identifiers are selected from the group consisting of: computer components certified for use with a class of computers, computer components certified for use with a one or more software components, and computer components certified for use with the particular computer configuration.

4. The method of claim 3, further comprising the steps of:
(d) determining the at least one identifier is not located within the collection of identifiers; and
(e) transmitting a notification to a user indicating the at least one identifier is not located within the collection of identifiers.

5. The method of claim 3, further comprising the steps of:
(d) determining the at least one identifier is located within the collection of identifiers; and
(e) performing step (b).

6. The method of claim 1, further comprising the step of:
(c) determining the computer component is compatible with the particular computer configuration; and
(d) notifying a user that the computer component is compatible with the particular computer configuration.

7. The method of claim 1, wherein the at least one identifier is embodied in items selected from the group of: a bar code, UPC code, an IR-reflective pattern, RFID tag, and combinations thereof.

8. The method of claim 1, wherein the at least one identifier is located at a location selected from the group consisting of: a portion of the computer component, a portion of the packaging, and combinations thereof.

9. The method of claim 6, further comprising the step of:
(e) placing electronic content regarding the detected component on a computer-readable medium in operative communication with the computing device.

10. The method of claim 6, further comprising the step of:
(e) notifying a user of a recommended additional computer component that is compatible with both the computing device and the computer component detected.

11. A computer-readable medium having computer-executable instructions for a method of installing a computer component in a computer having a computer configuration comprising the steps of:
(a) detecting at least one identifier of a computer component associated with a packaging in proximity to a sensor operatively connected to a computing device having a particular configuration, the identifier comprising information relating to the computer component, wherein detection of the at least one identifier is performed without substantially altering the packaging;
(b) comparing at least a portion of the information relating to the computer component with a particular computer configuration to obtain a comparison result, the comparison result conveying information selected from the group consisting of: the computer component is compatible with the computing device; the computer component is not compatible with the computing device, and the computer component may be compatible with modifications to the computing device.

12. The computer-readable medium of claim 11, the instructions further performing the steps of:
(c) determining the computer component is not compatible with the computer device; and
(d) determining at least one configuration update that will allow the computer component to be compatible with the computing device.

13. The computer-readable medium of claim 12, the instructions further performing the steps of:
(e) installing at least one configuration update to the computing device, wherein the at least one configuration update renders the computer component to be compatible with the computing device.

14. The computer-readable medium of claim 12, the instructions further performing the steps of:
(c) determining the computer component is compatible with the computer device; and
(d) presenting an indication to a user that the computer component is compatible with the computing device.

15. The computer-readable medium of claim 14, the instructions further performing the steps of:
(e) presenting to a user at least one additional component selection that is compatible with the computer configuration.

16. The computer-readable of claim 12, wherein the at least one identifier is embodied in items selected from the group of: a bar code, UPC code, an IR-reflective pattern, RFID tag, and combinations thereof.

17. The method of claim 12, wherein the at least one identifier is located at a location selected from the group consisting of: a portion of the computer component, a portion of the packaging, and combinations thereof.

18. The computer-readable medium of claim 14, wherein at least one identifier is located on the computer component, the instructions further performing the steps of:
(e) upon being previously installed in the computing device, rescanning the computer component at a second computing device to determine compatibility of the computer component with a second the computing device to generate a result; and
(f) present the result to a user.

19. A computer component packaging apparatus comprising:
a packaging configured to be associated with a computer component; and
at least one identifier configured to be externally detectable from at least a portion of the packaging, the at least one identifier comprising information relating to the computer component, wherein detection of the at least one identifier is performed without substantially altering the packaging.

20. The packaging apparatus of claim 19, wherein at least one identifier is located at a location selected from the group consisting of: a portion of the computer component, a portion of the packaging, and combinations thereof.
